(19) United States
(12) Patent Application Publication
(10) Pub. No.: US 2019/0325408 A1
(43) Pub. Date: Oct. 24, 2019

(54) Devices, Systems, and Methods For Securing, Accessing and Transacting Cryptocurrency and Non-Crytptocurrency Assets

(71) Applicant: Xeeda Inc., Irvine, CA (US)

(72) Inventors: Marc Goroff, Livermore, CA (US); Kevin Maloney, INewport Beach, CA (US); Seyed Parham Sadrizadeh, Irvine, CA (US); Amirhossein Mansourighasri, Los Angeles, CA (US)

(73) Assignee: Xeeda Inc., Irvine, CA (US)

(21) Appl. No.: 16/460,758

(22) Filed: Jul. 2, 2019

Related U.S. Application Data
(63) Continuation-in-part of application No. 16/237,639, filed on Dec. 31, 2018.
(60) Provisional application No. 62/618,305, filed on Jan. 17, 2018.
(60) Provisional application No. 62/612,355, filed on Dec. 30, 2017.

(51) Int. Cl. G06Q 20/06; G06Q 20/38; G06Q 20/40; G06Q 20/20

(52) U.S. Cl. CPC G06Q 20/0658; G06Q 20/3829; G06Q 2220/00; G06Q 20/3825; G06Q 20/202; G06Q 20/40145

(57) ABSTRACT

A system for secure transactions of information is provided herein, where the system includes a computing device having a software application installed thereon and is configured to store a public cryptocurrency key and a hardware encryption device configured to store a private encryption key, and is configured to selectively connect in data communication to the computing device for signing an cryptocurrency transaction. The computing device broadcasts a signed transaction received from the hardware encryption device for verification of the transaction.

This application is a continuation-in-part that claims the benefit of priority and the filing date pursuant to 35 U.S.C. § 120 to U.S. Non-Provisional patent application Ser. No. 16/237,639, filed Dec. 31, 2018, which claims priority pursuant to 35 U.S.C. § 119(e) to U.S. Provisional Patent Application Ser. No. 62/618,305, filed Jan. 17, 2018, and U.S. Provisional Patent Application Ser. No. 62/612,355, filed Dec. 30, 2017, the content of each which is hereby incorporated by reference in its entirety.

### BACKGROUND

The subject of this patent application relates generally to systems and methods for use in the storing and transacting information, particularly sensitive online information through use of one or both of a software and hardware. Such information includes ledger-based information including block-chain-based information including cryptocurrency assets and tokens.

By way of background, in any cryptocurrency transaction and storage (such as Bitcoin, or other non-Bitcoin currencies collectively known as Altcoins), a private key and public key is required to complete the transaction. The public key is similar to an account number which facilitates the transmission of funds thereto. The private key is kept confidential; and is used to sign outgoing payments (e.g., sending funds to other accounts).

Since the access and knowledge of the private key determines ownership of the cryptocurrency funds (stored in a “wallet”), keeping the private key secure and confidential has proven to be a great challenge. Further, the anonymous nature of cryptocurrencies and the lack of safeguards makes these currencies prime targets for phishing attacks, viruses, malware, etc. with the aim of stealing the funds.

Existing security solutions for cryptocurrencies have shortcomings and are often difficult for the average user to adopt. Existing solutions include storing the assets on online exchanges and wallets, storing the assets on local computers (desktops, laptops, mobile devices, etc.). Online wallets have been targets of hacks or unscrupulous owners who abscond with the client funds. Non-air gapped local storage solutions, again, are vulnerable to various attacks, and rely on the user's personal knowledge of cyber security, which is usually lacking.

Aspects of the present invention fulfill these needs and provide further related advantages as described in the following summary.

### SUMMARY

Aspects of the present invention teach certain benefits in construction and use which give rise to the exemplary advantages described below.

The present invention solves the problems described above by providing a method and system for secure transactions of cryptocurrencies is provided herein, where the system includes a computing device having a software application installed thereon and is configured to store a public cryptocurrency key. And further includes a hardware encryption device configured to store a private cryptocurrency encryption key, and is configured to selectively connect in data communication to the computing device for signing an cryptocurrency transaction. The computing device broadcasts a signed transaction received from the hardware encryption device for verification of the transaction.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a simplified schematic view of an exemplary system for facilitating the transaction of cryptocurrencies using one or more computing device and a hardware encryption device, in accordance with at least one embodiment;

FIG. 2 is a flow chart of the present software implemented system and method, using the present hardware encryption device in accordance with at least one embodiment;

FIGS. 3A-H showing the hardware encryption device according to the present invention, with FIG. 3A is a perspective view of the hardware encryption device according to the present invention; FIG. 3B is a top view of the hardware encryption device of FIG. 3A; FIG. 3C shows a bottom view of the hardware encryption device of FIG. 3A; FIG. 3D is an exploded perspective view of the hardware encryption device according to the present invention; FIG. 3E is a perspective view of internal components of the hardware encryption device according to the present invention; FIG. 3F is a landscape side view of the internal components of FIG. 3E of the hardware encryption device according to the present invention; FIG. 3G is a perspective view of one embodiments of the hardware encryption device according to the present invention; and FIG. 3H is a perspective view of another embodiment of the hardware encryption device according to the present invention.

FIGS. 4A-B is a flow chart of the system and method of FIG. 2, showing greater detail with FIG. 4A showing the security protocol and FIG. 4B showing menu selection.

FIG. 5 is a flow chart of the present software implemented system and method, using the present hardware encryption device in accordance with at least one additional embodiment thereof.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments

### DETAILED DESCRIPTION

The detailed descriptions set forth below in connection with the appended drawings are intended as a description of embodiments of the invention, and is not intended to represent the only forms in which the present invention may be constructed and/or utilized. The descriptions set forth the structure and the sequence of steps for constructing and operating the invention in connection with the illustrated embodiments. It is to be understood, however, that the same or equivalent structures and steps may be accomplished by different embodiments that are also intended to be encompassed within the spirit and scope of the invention. In addition, while the present computer implemented system and method and hardware encryption device are described with respect to the storing and transacting of cryptocurrency assets and tokens, the present invention can be used to store and transact any type of information, particularly sensitive information that can be accessed online, including but not limited to information regarding financial accounts, voting systems, social media, medical records, emails as well as ledger-based information including non-cryptocurrency block-chain-based information.

The present system and method provides a software implemented method installed on one or, preferably both of a local computing device (e.g., a smartphone, a laptop, desktop, and the like) and a hardware encryption device. The present software implemented system and method facilitate the securing and transacting cryptocurrencies by storing the private key in a secure hardware encryption device (or hardware wallet), other than within smartphones or other local computing device accessible by the user). The present device stores the private key and selectively connects to the smartphone for signing the transactions. Multiple authentication processes are disclosed and used in conjunction with the presently technology.

Computer networks are well known in the art, often having one or more client computers and one or more servers, on which any of the software implemented methods and systems of various disclosed embodiments may be implemented. In particular the computer system, or server in this example, may represent any of the computer systems and physical components necessary to perform the computerized methods discussed in connection with the present figures and, in particular, may represent a server (cloud, array, etc.), client, or other computer system upon which e-commerce servers, websites, databases, web browsers and/or web analytic applications may be instantiated.

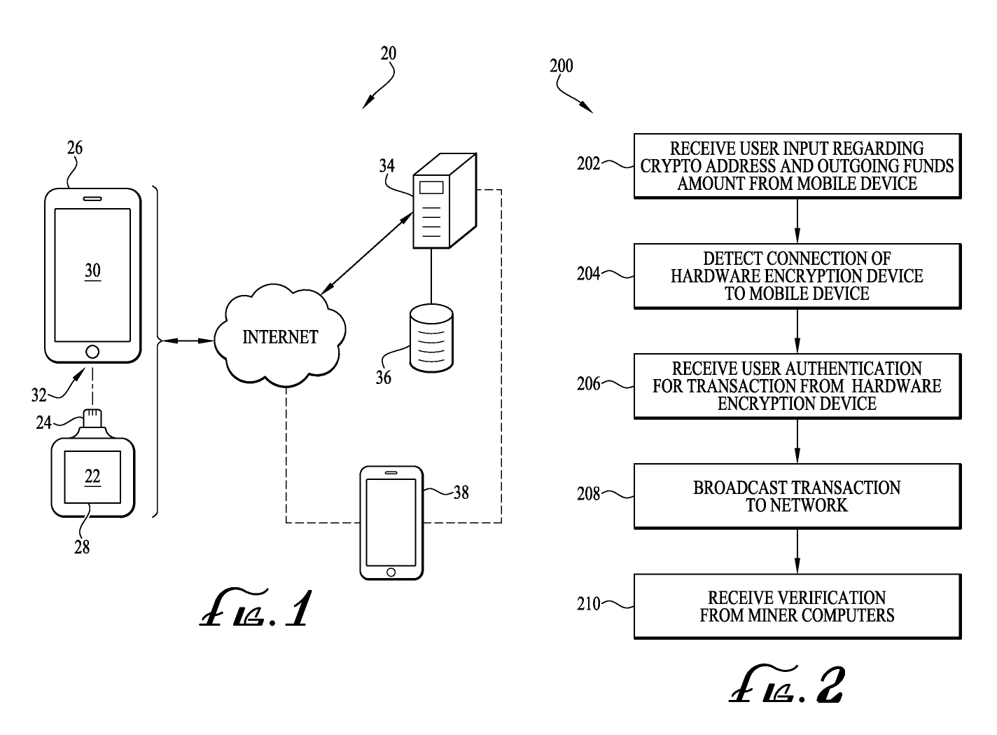

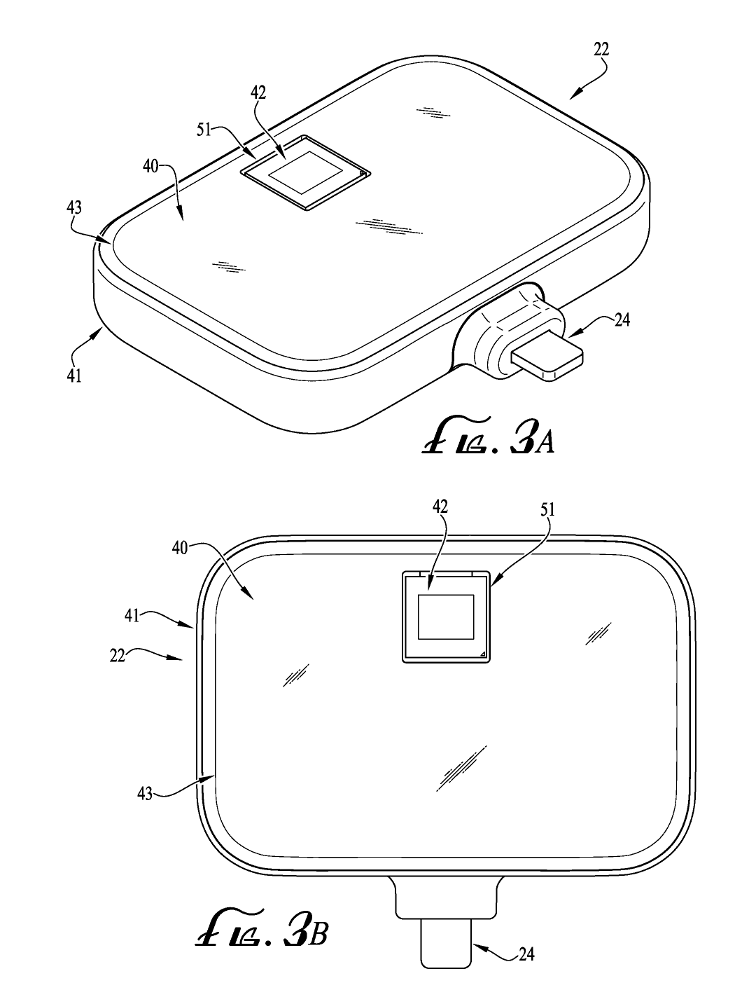

Referring to FIG. 1, an exemplary system 20 illustrates an exemplary server 34 (acting as a miner computer) with associated database 36, an optional second computer device 38, and the local computing device 26 (a smartphone, in this example) are generally known to a person of ordinary skill in the art, and each may include a processor, a bus for communicating information, a main memory coupled to the bus for storing information and instructions to be executed by the processor and for storing temporary variables or other intermediate information during the execution of instructions by processor, a static storage device or other non-transitory computer readable medium for storing static information and instructions for the processor, and a storage device, such as a hard disk, may also be provided and coupled to the bus for storing information and instructions.

The miner computer 34 and other computing devices 26, 38 may optionally be coupled to a display for displaying information. However, in the case of server 34, such a display may not be present and all administration of the server may be via remote clients. Further, the server 34 and other computers 26, 38 may optionally include connection to an input device for communicating information and command selections to the processor, such as a keyboard, mouse, touchpad, microphone, and the like. Moreover, the computers and the hardware encryption device 22 may optionally include connection to an output device for communicating information. The present hardware encryption device 22 is connected to the smartphone 22, only when required for transactions requiring authorization using the private key, via a bus connector 24 (e.g., a LIGHTNING connector, a micro-USB connector, a USB-C connector, and the like.). The hardware encryption device 22 can optionally include a touchscreen 28 or other screen for communicating information to the user, receiving password or biometric information (e.g., a fingerprint scan, a retinal scan, a voice recognition scan, or a facial recognition scan—although a separate biometric reader may be included), and for receiving other user input. As will be discussed further below, in one embodiment, the connector 24 is rigidly or flexibly mounted directly to the hardware encryption device 22, for example, being mounted to a board therein and extending directly from the housing 48. Connection to the smartphone 26 may be made using wireless connections (such as BLUETOOTH®, or other standard or custom wireless protocols) or through an integral or separate cable (not shown).

At the outset, it should be noted that communication between each of the smartphone 26, the miner computer 34, and other computer 38 may be achieved using any wired- or wireless-based communication protocol (or combination of protocols) now known or later developed. As such, the present invention should not be read as being limited to any one particular type of communication protocol, even though certain exemplary protocols may be mentioned herein for illustrative purposes. It should also be noted that the various computers or computing devices described are intended to include any type of computing or electronic device now known or later developed, such as desktop computers, mobile phones, smartphones, laptop computers, tablet computers, virtual reality systems, personal data assistants, gaming devices, POS systems, vending machines, unattended terminals, access control devices, point of interaction (“POI”) systems, etc.

The mining computer 34, smartphone, and the remote or other computer 38 may also include a communication interface coupled to the bus, for providing two-way, wired and/or wireless data communication to and from the server and/or client computers. For example, the communications interface may send and receive signals via a local area network, public network, intranet, private network (e.g., a VPN), or other network, including the Internet.

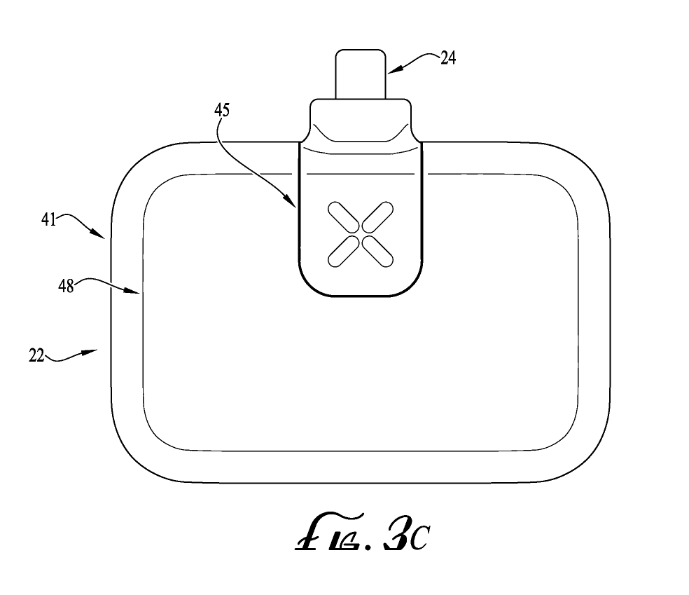

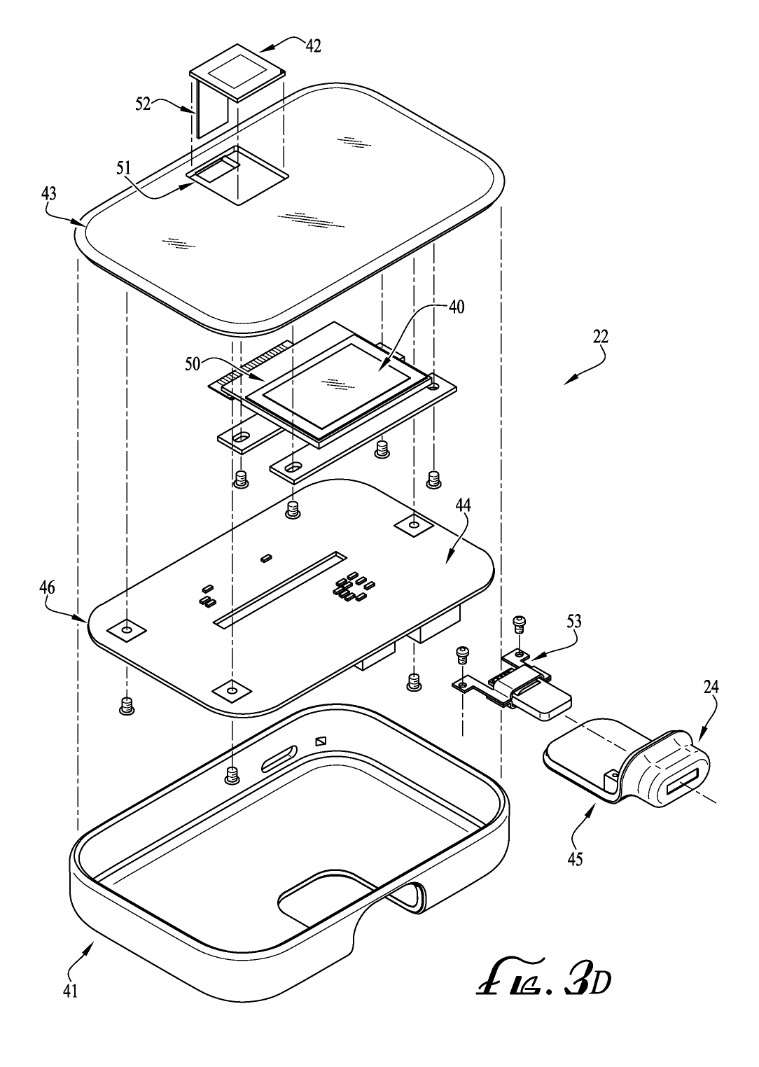

In the present illustrated example, the hard drive of the user smartphone 26 and the hardware encryption device 22 are encoded with executable instructions, that when executed by a processor (in each device) causes the processor to perform acts as outlined in FIGS. 2, 4 and 5. In an example embodiment, the user interacts with the smartphone 26 to access and interact with the graphical user interface through either a web application running on a mobile web browser or a mobile application (commonly called an “app”) installed on the smartphone 26 and displayed on the screen 30. The application installed on the smartphone 26 communicates and sends/receives data to/from the hardware encryption device 22, when the device connector 24 is inserted into and in data communication with the smartphone 26, through the smartphone connector 32.

Referring now to FIG. 2, which broadly describes one example embodiment of the present method 200, the user decides to which address to send the funds, which can be entered into the user interface displayed on the smartphone 26 display 30, with or without the hardware encryption device 22 connected. The application installed on the smartphone 26 receives the user in destination cryptocurrency address and the amount of funds to be sent to that address, step 202. The hardware encryption device 22 stores the cryptocurrency private key or keys, and includes a stored amount of funds in token form (such as n number of Bitcoins). The application on the smartphone 26 and/or the application installed on the hardware encryption device 22 detects when the hardware encryption device 22 is in data communication with the smartphone 26, step 204. The application installed on the smartphone 26 receives an authorization to perform the transaction, as defined by the user, from the hardware encryption device 22, step 206, and the funds to be transferred are sent to the hardware wallet on the smartphone, while the remaining funds remain on the hardware encryption device 22. The transaction is confirmed by the user and signed by the private key on the hardware encryption device 22. The application installed on the smartphone, then broadcasts the signed transaction to the network, step 208, where the miner computer(s) verify the transaction. Thereafter, the verification for the transaction is received by the application installed on the smartphone 26, step 210. The hardware encryption device 22 may be in data communication with the smartphone 26 throughout the transaction, or may be optionally detached or disconnected from the smartphone 26 after it send the authorization to the smartphone.

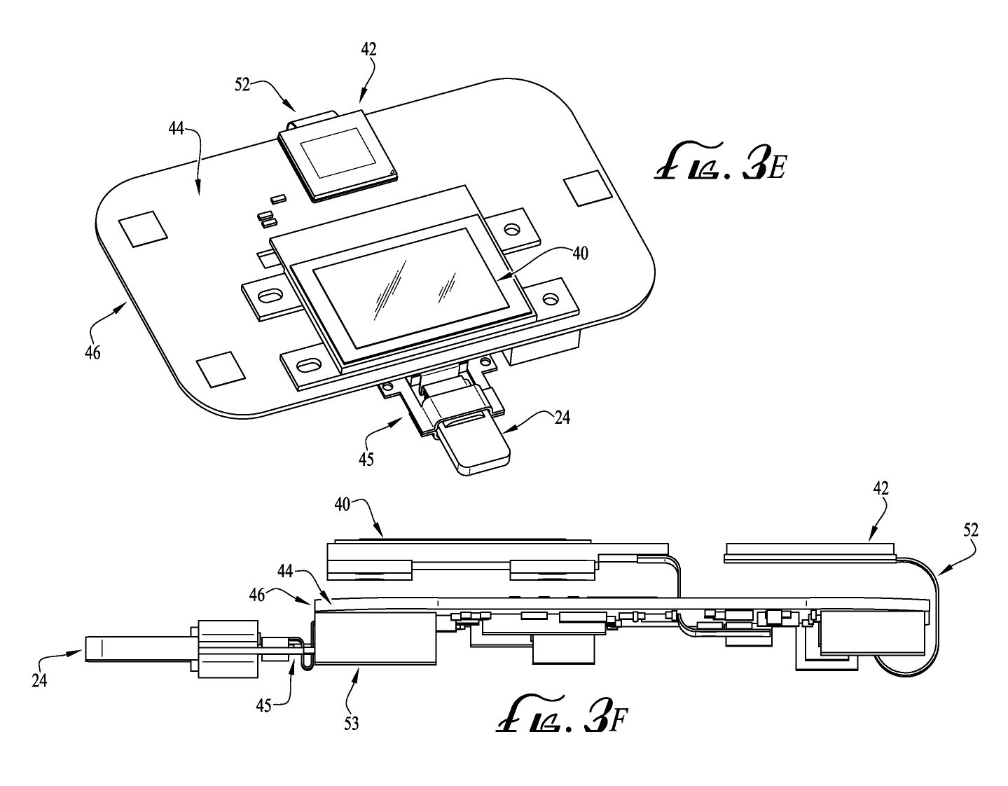

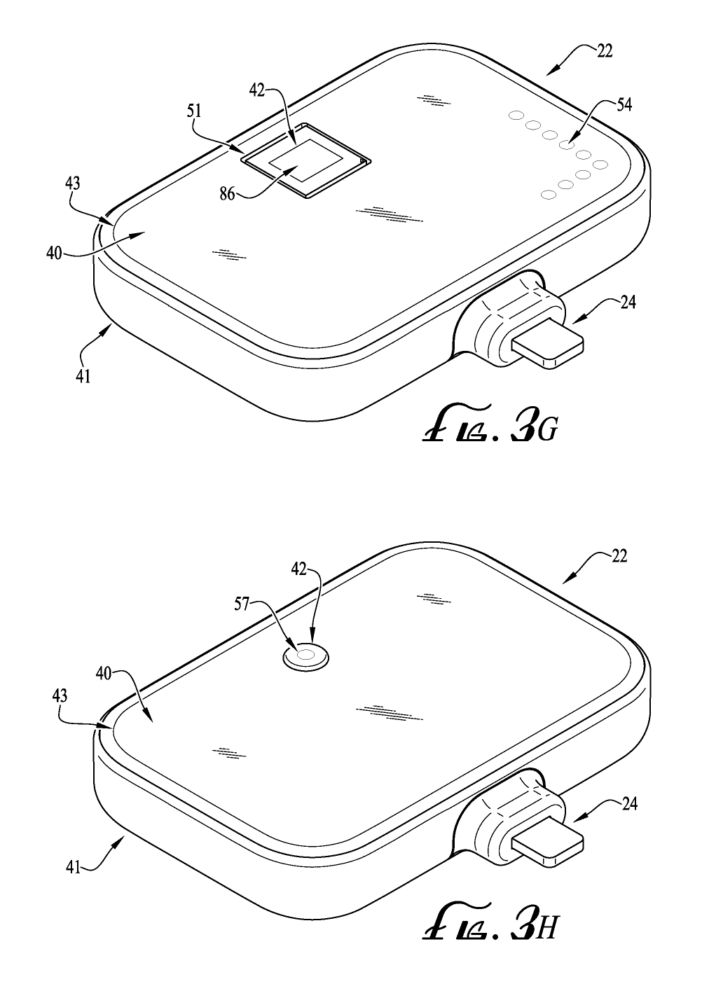

FIGS. 3A-3F illustrate a hardware encryption device 22 according to the present invention. The hardware encryption device 22 generates and stores the private key in a secure microcontroller (secure element), and FIGS. 3A-3F show various features involved in generating and storing the private key, as well as other aspects involved in confirming a cryptocurrency transaction or other activity. As illustrated in FIG. 3A-3B, the hardware encryption device 22 includes a housing 41, a touchscreen display 40, and biometric authentication element(s) 42, and a port 24 that provides a physical connection between the hardware encryption device 22 and a smartphone or other computing device 26. FIG. 3C shows a bottom or under side 48 of the housing 41 of the hardware encryption device 22, where the port 24 is affixed thereto with a supporting plate 45 (also shown in FIG. 3D).

FIG. 3D shows an exploded perspective view of the various components of the hardware encryption device 22. A first substrate serving as a support frame 46 is placed within the housing 41, and a printed electronic circuit board (PCB) 44 having a microcontroller and associated components 50 are coupled to the support frame 46. The touchscreen display 40 is positioned on top of the microcontroller and associated components 50, and may have a second substrate between it and the microcontroller and associated components 50. The touchscreen display 40 may have an aperture 51 therein for the biometric authentication element(s) 42, which may have a supporting element 52 (flexible or rigid) that is insertable into the touchscreen display 40 for coupling the biometric authentication element(s) 42 to the printed electronic circuit board 44. It is to be understood that the touchscreen display 40 may comprise all, substantially all, or a portion of a top surface 43 of the hardware encryption device 22.

The connection port 24 may include electronic components 53 which enable the port 24 to communicate with the PCB 44 to send and receive information to and from a device 26 to which the hardware encryption device 22 is coupled. The connection port 24 could be different based on the type of smartphone or other mobile device that is being used in conjunction with the device. The type of bus connection is not limited to mobile connectors such as e.g., a LIGHTNING connector, a micro-USB connector, a USB-C connector, and the like; and it could be any other related connection method such as USB connectors for desktops. The hardware encryption device 22 can also include a battery pack, such as a lithium ion battery pack, which can be used to recharge the smartphone or other mobile device 26. The battery pack will not power the hardware encryption device 22 or components therein and may be wired directly to the connector to serve as an external back-up power source for the smartphone or other mobile device 26. Alternatively, or in addition to, the hardware encryption device 22 can also include wireless or inductive back-up charging capabilities to wirelessly recharge the smartphone or other mobile device 26 without being connected to such a mobile device. In addition, the hardware encryption device 22 can include a storage chip that allows a user to securely store photos, music, documents, or other important information within the encryption device 22.

FIG. 3E shows a perspective view of the internal components of the hardware encryption device 22 in their coupled configuration relative to each other, without the housing 41 or support frame 46. FIG. 3F shows a side view of these internal components as in FIG. 3E, with the connection port 24 on the left side of FIG. 3F and the touchscreen display 40 on the right side thereof.

FIGS. 3G-3H illustrate embodiments of the hardware encryption device 22 that include additional features. A hardware encryption device can include navigational elements that allow a user to interface with a touchscreen display including, without limitation, capacitive sensing, including surface capacitance and projected capacitance. Navigational elements comprise one or more sensing elements, including capacitive input elements. In aspects of this embodiment, navigational elements can comprise, e.g., at least 2 sensing elements, at least 3 sensing elements, at least 4 sensing elements, at least 5 sensing elements, at least 6 sensing elements, at least 7 sensing elements, at least 8 sensing elements, at least 9 sensing elements, or at least 10 sensing elements. In other aspects of this embodiment, navigational elements can comprise, e.g., at most 2 sensing elements, at most 3 sensing elements, at most 4 sensing elements, at most 5 sensing elements, at most 6 sensing elements, at most 7 sensing elements, at most 8 sensing elements, at most 9 sensing elements, or at most 10 sensing elements. In other aspects of this embodiment, navigational elements can comprise, e.g., about 2 to about 3, about 2 to about 4, about 2 to about 5, about 2 to about 6, about 2 to about 7, about 2 to about 8, about 2 to about 9, about 2 to about 10, about 3 to about 4, about 3 to about 5, about 3 to about 6, about 3 to about 7, about 3 to about 8, about 3 to about 9, about 3 to about 10, about 4 to about 5, about 4 to about 6, about 4 to about 7, about 4 to about 8, about 4 to about 9, about 4 to about 10, about 5 to about 6, about 5 to about 7, about 5 to about 8, about 5 to about 9, about 5 to about 10, about 6 to about 7, about 6 to about 8, about 6 to about 9, about 6 to about 10, about 7 to about 8, about 7 to about 9, about 7 to about 10, about 8 to about 9, about 8 to about 10, or about 9 to about 10, sensing elements.

A user may manipulate navigational elements to maneuver to different locations on a touchscreen display to perform different functions in conjunction with the touchscreen display, such as, e.g., selecting menu items and positioning a cursor or other indicator to enter information into the hardware encryption device. In one embodiment, and referring to FIG. 3G, hardware encryption device 22 having navigational elements 54 positioned in a “backward L” configuration along a horizontal and a vertical boarder of the touchscreen display 40. It is to be understood that the navigational elements 54 may be positioned anywhere on the touchscreen display 40 or on the housing 41 of the hardware encryption device 22, and therefore the present invention is not to be limited to any particular configuration illustrated in FIG. 3G. It is to be further understood that the navigational elements 54 may comprise any type of arrangement that enables a user to operate within a display environment using the display 40, whether it be touch-enabled or otherwise. For example, the navigational elements 54 may be raised relative to a surface of the hardware encryption device 22, and may be movable (so as not to be fixed relative to the surface) or non-movable (so as to be fixed relative to the surface). Where movable, the navigational elements 54 may move within a designated track, so as to rotate or slide.

FIGS. 3A-3G show a fingerprint scanner 56 as the biometric authentication element(s) 42 of the hardware encryption device 22. As noted above however, the biometric authentical elements 42 may include multiple devices for collecting a user's biometric credentials, such as for example a fingerprint scanner, a retinal scanner, a voice recognition scanner, or a facial recognition scanner. FIG. 3H illustrates that the biometric authentication element(s) 42 of the hardware encryption device 22 may also include a camera 57 that is capable of serving as a retinal scanner or a facial recognition scanner or both.

The present hardware encryption device 22 (hardware wallet) uses hierarchical deterministic key generation to derive a theoretically infinite number of cryptographic secrets from a single master seed. In this way, the cryptocurrency private keys, passwords, and other cryptographic secret data can all be determined and intrinsically stored in a single master seed. The hardware encryption device 22 can use the BIP39 industry standard for creating the master seed, and uses BIP32 industry standard for HD key generation and BIP44 for the handling of multiple coins, multiple accounts, external and internal chains per account and millions of addresses per chain, which allows the creation of an infinite number of wallets and private keys for cryptocurrency coins.

The hardware encryption device 22 includes two hardware chips. Chip one is a standard I/O microcontroller such as but not limited to a STM32 microcontroller. This part is in charge of input and output signals and does not store the private key, The other part of the PCB that stores the private key and interactions with the Secure Microcontroller Units (ST MCU) through the 10 pins. Secure MGU is a tamper resistant chip that is generally used for storing cryptographic information, The hardware encryption device 22 does not require any battery to operate. The hardware wallet uses the cellphone power to operate, and is dormant when disconnected. Alternatively, an onboard or external power source may be provided to the hardware encryption device 22.

In one or more embodiments, the hardware encryption device 22 does not have any port, and uses wireless data transfer protocols such as BLUETOOTH®, near-field communication (NFC), Wi-Fi™, ZIGBEE®, or any other related protocols to sign the transactions. The smartphone 26 application automatically detects the surrounding for the hardware encryption device 22. If the hardware encryption device 22 (or hardware key) is found, it requests conformation for entering the next layer of authentication such as biometrics sensor or password. The hardware encryption device 22 does not trust any request made by the device it is plugged into. It requires the user to confirm any request made to it via a built in biometric scanner. The hardware encryption device 22 contains the user's private keys stored in an EAL5+ secure element. The keys never leave that element.

In one or more embodiments, the hardware encryption device 22 is equipped with biometric sensors such fingerprint, face, or eye detection to authenticate and sign the transaction. The sensors are installed on the hardware encryption device 22. The device could be powered to use some pre-defined transactions. Such pre-defined transactions could be transferring some predefined amounts to the wallet on the smartphone 26 that does not require the hardware encryption device 22 to sign. This feature could be used if users need to hold large balances in the hardware encryption device 22 and smaller balances for everyday use in the mobile app wallet on the smartphone 26. The hardware encryption device 22 could have a single button to transfer the pre-defined amounts to the smartphone 26 wallet that doesn't require hardware wallet.

In one or more embodiments, the hardware encryption device 22 can independently make a transaction. The hardware encryption device 22 has all the required wireless communication protocols (such as but not limited to, NFC, BLUETOOTH®, W-Fi™ and ZIGBEE®) to make payments directly. For example, the hardware encryption device 22 can be configured to communicate directly (peer-to-peer) with merchant point of sale (POS) devices or other computing device. The users use the biometric authentication methods or passcodes to authenticate and send transaction for everyday use.

All transactions are signed by the hardware encryption device 22 via an API in which the application sends the requested transaction to be signed to the hardware encryption device 22. A display on the hardware encryption device 22 displays all the parameters of the requested transaction and requests user confirmation via a fingerprint scanner internal to the hardware encryption device 22. The user confirms the transaction by a successful fingerprint match at which point the hardware encryption device 22 signs the transaction with the users embedded private key and returns the signed transaction to the application for sending to the blockchain.

There are numerous layers of protection within the hardware encryption device 22 to prevent hacking of the device. All firmware in the hardware encryption device 22 is signed with a code signing private key. The processing elements within the hardware encryption device 22 are preprogrammed with the code signing public key which is used to verify the downloaded firmware is a compatible and permitted product before that firmware is executed.

The hardware encryption device 22 contains a processing element that has numerous layers of physical tamper protection. For example, a Maxim Deep Cover ARM processor or the like. This processor controls the display and performs the biometric (fingerprint, facial recognition, etc.) match. The biometric scanner in the hardware encryption device 22 communicates with the processor over a TLS secured SPI bus. This makes the biometric matching immune to replay attacks.

The Secure Element used in the hardware encryption device 22 is also talking on a TLS secured SPI bus only to the ARM processor. This thwarts any replay attacks. During the initial hardware encryption device 22 initialization process in manufacturing, the ARM processor generates a unique random key which is then sent to the Secure Element. The Secure Element stores this key and from that point on will require all messages over the SPI bus to be signed by that unique immutable key. This protects from an attack where the Secure Element is removed from the original hardware encryption device 22 and is then placed in another hardware key in an attempt to bypass the biometric authentication.

The process of entering a BIP39 seed phrase is done entirely on the hardware encryption device 22 using its internal display and biometric scanner so that the seed phrase is never entered in the host smartphone 26 or other computing device. In addition, the hardware encryption device 22 supports a two-factor seed phrase and password. Again, all are entered directly on the hardware encryption device 22, never on the host device (e.g., the smartphone 26), thus never leaving the hardware encryption device 22 and is immune to snooping attacks.

In one or more example embodiments, a true random number generator in the ARM processor can be used to generate a unique salt for each hardware encryption device 22 that is used in the BIP39 initialization. This would produce a mnemonic phrase that's unique to this hardware encryption device 22. The system 20 (or company or organization that controls or manages the system) knows the mapping between each hardware encryption device 22 and that unique salt. Should a user lose their hardware encryption device 22, they must prove to the system manager that they are the owner of a particular hardware encryption device 22, in order for the production of a replacement hardware encryption device 22 with the same salt as the original hardware encryption device 22. They can then enter their mnemonic phrase into the new hardware encryption device 22 to regenerate their private keys. Without having the same salt in the hardware encryption device 22, the mnemonic phrase would be useless in regenerating their private keys. This adds yet another level of authentication required for using the mnemonic phrase to generate keys.

In order to make it easier for the end user to perform daily trading while securing their assets, the present system uses a hot wallet and cold wallet. Wallets or private keys can be generated and stored in the application on the smartphone 26 or in the hardware encryption device 22. The user can transfer the cryptocurrency assets between the hot wallet (with the private key stored in the application) and cold wallet (with the private key stored in the hardware encryption device 22). In this way, the user can have a small amount of cryptocurrency in the hot wallet for quick transactions, and, yet, transmit the funds to the hardware encryption device 22 (hardware wallet) for higher level security.

The present hardware encryption device 22 best performs in conjunction with mobile app that provides an integrated ecosystem for the end user. The application is the main gateway for interacting with cryptocurrency networks. The present application is used as multi-token cryptocurrency wallet, and is used to send and receive coins. In general, receiving cryptocurrency does not require the hardware encryption device 22 to be connected. Sending any funds out requires the presence of the hardware encryption device 22. When the recipients address and the amount to be sent is defined, the application looks for the related private key on the hardware encryption device 22 to sign the transaction. Existing smartphone authentication is used to unlock the hardware encryption device 22, and authorizes the owner of the device. A personal identification (PIN) code can be entered on the device as a backup authentication method.

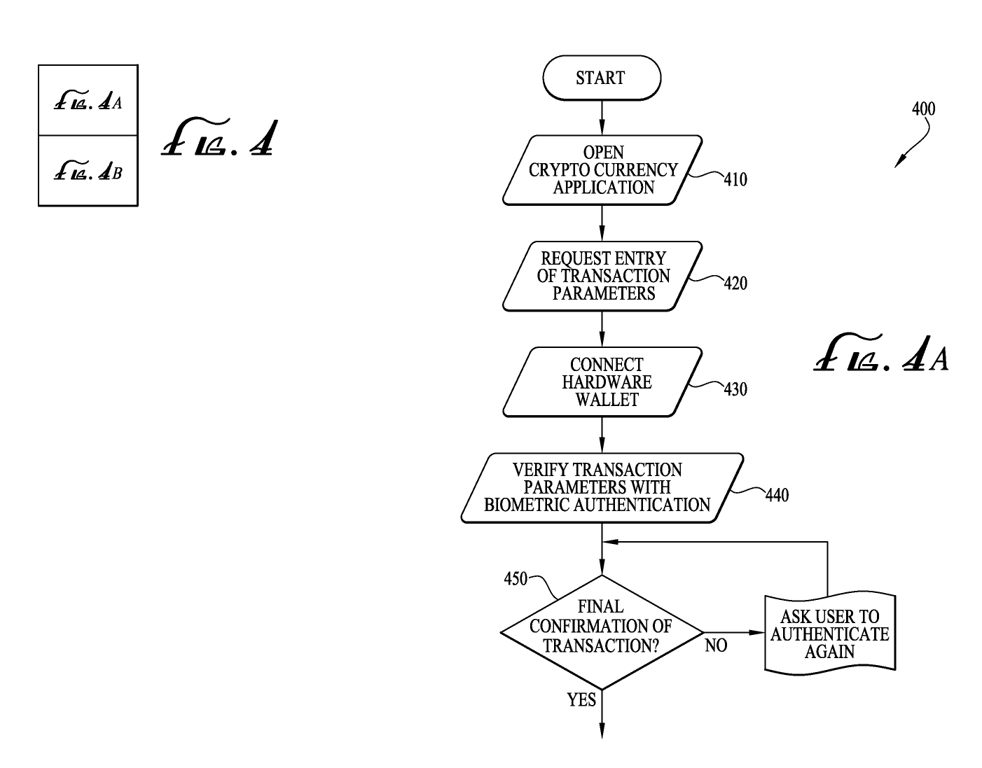

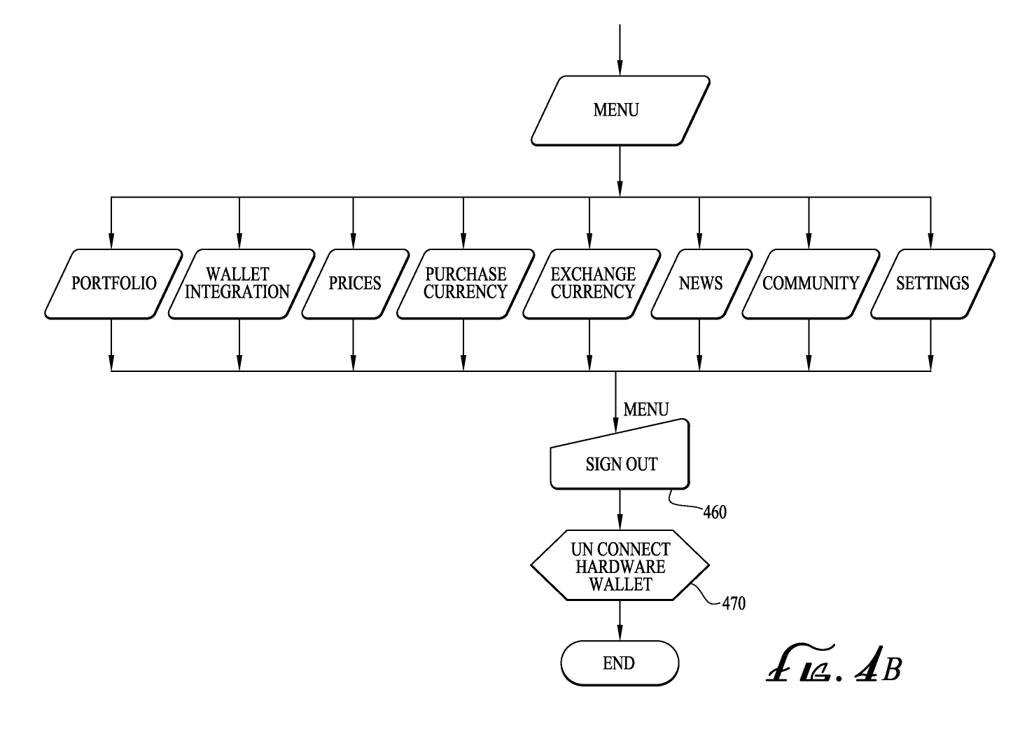

FIGS. 4-4C illustrate the method of FIG. 2 in greater detail, showing a flow chart of the present method 200. FIGS. 4A-4C generally set forth a process 400 of steps involved in a user's interaction with the hardware encryption device 22. In one embodiment of such a process 400, a user opens a cryptocurrency application on their smartphone or smart computing device 26 at step 410 as shown in FIG. 4A. It is to be noted that this cryptocurrency application can be any application resident on a smartphone 26 or accessible by a smartphone 26, and need not be a dedicated application. Regardless, the process 400 requests that the user enter transaction parameters at step 420 and insert the hardware encryption device 22 into the smartphone 26, if this has not already been done, at step 430. Note that the hardware encryption device 22 can be attached before or after steps 410 and 420. It is to be further noted that when the hardware encryption device 22 is unplugged or removed from the smartphone 26, this is a “cold” cryptocurrency wallet, whereas the hardware encryption device 22 becomes a “hot” wallet when coupled to the smartphone 26 for executing cryptocurrency transactions (or performing other activities requiring authentication).

The transaction parameters are sent to the hardware encryption device 22 to be displayed on the touchscreen display 40 configured thereon. The process 400 then verifies transaction parameters, for example by requesting that the user enter a yes or no via the touchscreen display 40, and proceeds with confirming the verification using the biometric authentical element(s) 42 on the hardware encryption device 22 at step 440. Optionally, a further or final confirmation may be requested of the user, for example by entering a PIN or other code on hardware encryption device 22. The hardware encryption device 22 may include navigational elements to facilitate inputting of the PIN or other code. Regardless, confirmation that the transaction has been authenticated is shown at step 450.

The user may utilize the application on the smartphone or smart computing device 26 to perform a wide array of cryptocurrency transactions, as shown in FIG. 4B. The user may therefore employ the application to access multiple menu items and select a plurality of functions and settings for conducting cryptocurrency transactions, for example using different cryptocurrencies and on different cryptocurrency trading platforms. Regardless, it is to be understood that the user may conduct multiple types of cryptocurrency transactions using the smartphone 26 and the hardware encryption device 22 once authentication of the user has been verified.

In one or more embodiments, and referring to FIG. 4B, the present method can include methods of monitoring market changes of cryptocurrencies including current currency value or alerts for price changes of user-defined or predefined magnitudes (portfolio), methods of communicating with other wallet platforms used to store and manage cryptocurrencies (wallet integration), methods of monitoring current cryptocurrency market prices from one or more exchanges in order to display the current value of each cryptocurrency assets in each wallet in a flat currency in real-time and showing historical prices in the form of charts or numerical data (prices). Furthermore, the present method can include methods of purchasing additional cryptocurrency from one or more exchanges (purchase coins) or converting one form of cryptocurrency to another and/or to convert a cryptocurrency to a flat currency (such as the US dollar, the Euro, etc.) or vice versa (exchange coins), where thereafter, the funds can be transmitted to the hardware encryption device 22. Moreover, the present method can include methods of monitoring news fees, including financial and cryptocurrency specific information (news) as well as on-line forums (community). Lastly, the present method can include methods of selecting user-defined preferences and features (settings).

Final confirmation of the transaction is performed using the private key signature of hardware encryption device 22. Once this is accomplished, confirmation of the transaction is sent to the cryptocurrency application on the smartphone or other smart computing device 26, and the transaction parameters are then communicated on to a blockchain for recordation of the transaction. Referring to FIG. 4C, at step 460, the user signs out, and optionally the process 400 may request further biometric confirmation from the user. Regardless, after signing out the user may unplug the hardware encryption device 22 from the smartphone 26 at step 470, and the process 400 is reinitialized for new transaction parameters to be entered.

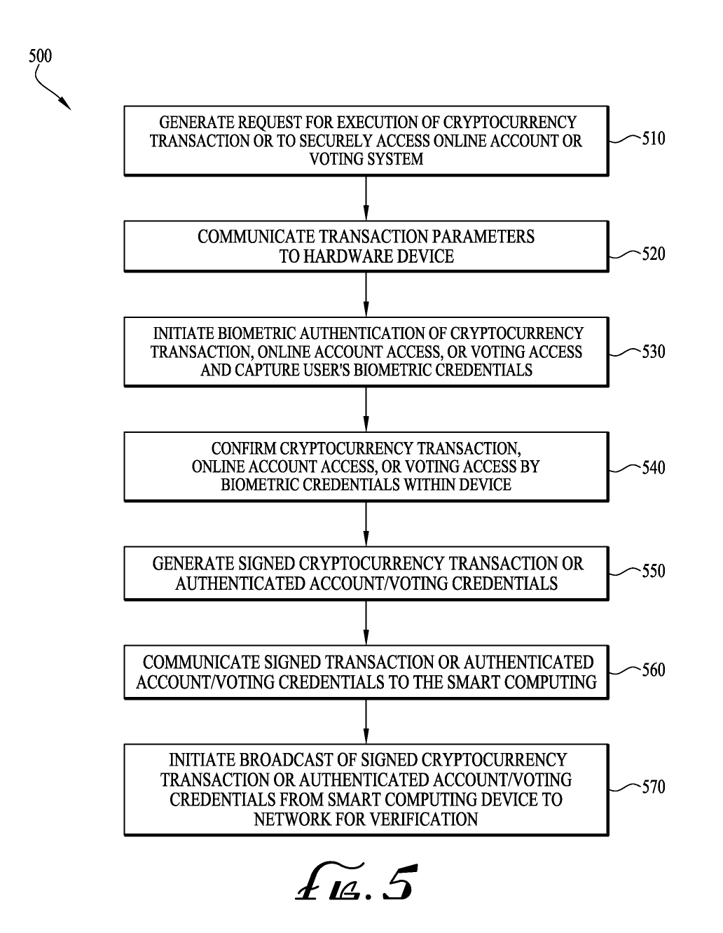

FIG. 5 illustrates a system and method of the present invention according to one or more additional embodiments thereof, in a flow chart of various steps in a process 500 of authenticating cryptocurrency transactions or access to secure systems such as online accounts (for example, as noted below, banking and social media), voting systems, and sensitive or confidential records within a mobile computing environment and using the hardware encryption device 22. In this process 500, systems and methods of the present invention are initiated, by way of example, when the hardware encryption device 22 generates a request for execution of a cryptocurrency transaction or to access a secure account or system as in step 510. In this step 510, a request may be generated by a user himself or herself via interaction with a touchscreen or other display 40 on the hardware encryption device 22 itself, via an application resident on the smartphone or smart computing device 26, or using another computing device 38. A request may also be automatically initiated when the hardware encryption device 22 is connected to a smartphone or other smart computing device 26, either via a physical connection port 24 or by a wireless connectivity method such as BLUETOOTH®, Wi-Fi™, NFC, ZIGBEE®, or any other wireless communications protocol.

Regardless, at step 520, transaction parameters are communicated to the smartphone or smart computing device 26. As noted above, a public cryptocurrency key is maintained on the smart computing device 26, and this key is confirmed using the private encryption key generated by the hardware encryption device 22 after the devices 22 and 26 are in data communication with each other. Confirmation of the public cryptocurrency key initiates the further authentication of the user and the cryptocurrency transaction or system access activity desired by the user via biometric authentication element(s) at step 530. The hardware encryption device 22 requests user interaction via the display 40, and performs one or more of a fingerprint scan, a retinal scan, a voice recognition scan, or a facial recognition scan as noted above to capture the user's biometric credentials.

At step 540, the user's biometric credentials are processed to confirm a cryptocurrency transaction, online account or records access, voting system access, or other activity. If and the biometric credentials are confirmed, the process 500 continues with executing the activity desired by the user. At step 550, a signed cryptocurrency transaction is generated by the hardware encryption device 22 (or a request for online/system/records access is authenticated and signed), and at step 560 this signed transaction is communicated to the smart computing device 26 for execution of the transaction or activity using one or more transaction components on the hardware encryption device 22.

At step 570, the present invention initiates a broadcast of the signed cryptocurrency transaction to a cryptocurrency network for verification by a miner computer, execution of the desired signed transaction, and writing of the transaction to a blockchain. Where the activity is a request to access an online system such as bank accounts or to vote, the present invention communicates the authenticated access request to the appropriate provider, and the user proceeds with conducting the desired activity. Where appropriate, this may also be written to a blockchain for recording the activity or transaction undertaken by the user, for example where cryptocurrency tokens are awarded for participating in online voting.

It is to be understood that where the present invention is utilized for cryptocurrency transactions, the hardware encryption device 22 enables a user to securely access one or more digital currencies in a blockchain with the private key, and conduct transactions using those digital currencies. It is to be further understood that many different types of transactions are contemplated. Transactions may include accessing digital currency accounts, managing such accounts, performing transfers between accounts or using a digital currency account, and effecting payments using digital currencies. The present invention is also not to be limited to any one type of digital currency mentioned herein, and therefore all digital currencies now known or to be developed are included within the scope thereof.

As indicated in FIG. 5, it is to be further understood that a hardware encryption device 22 also enables a user to securely access online services with one single private security key, and that therefore the present invention is not to be limited only to access or transactions using digital currencies. The hardware encryption device 22 is compliant with and may utilize authentication protocols such as FIDO Standard U2F for verifying access to online services requiring passwords or multiple layers of security, such as for example bank accounts, email, voting systems, social media accounts, and any other online information that is considered sensitive, such as medical, financial, or academic records. U2F is an open authentication standard that enables internet users to securely access online services with one single private security key instantly, and with no drivers or client software needed. FIDO2 is the latest generation of the U2F protocol, and technical specifications are hosted by the open-authentication industry consortium known as the FIDO Alliance.

The present invention may therefore be considered, in additional embodiments thereof, as a system and method for securely accessing one or more accounts requiring a heightened level of authentication. The hardware encryption device 22 and the private key may therefore be used in conjunction with the biometric authentication scanners described herein to access, manage, and engage with such accounts in a mobile computing environment in compliance with security protocols such as the FIDO2 protocol mentioned above.

It is to be further understood that the biometric authentication scanners may be selected randomly for confirming a private key in the present invention, and that therefore a different scanner may be utilized with the touchscreen display 40 each time the hardware encryption device 22 is inserted into a smartphone or smart computing device 26. Therefore, the hardware encryption device 22 may be configured with multiple biometric authentication scanners, and may be required to interact with the same or a different scanner via the touchscreen display 40 each time authentication is required.

In yet another embodiment of the present system and method, the user is rewarded when a transaction is made by the generation of proof of transaction tokens. For example, when the user completes a transaction with a merchant and/or a non-merchant (such as another user), at least part of a token is created for the user's wallet.

The quantity of proof of transaction tokens generated is determined by a mathematical algorithm, which includes the weighing of each type of transaction to determine the number of proofs of transaction tokens generated. In one example algorithm, the amount of proof of transaction tokens generated is calculated by: # of tokens=(K₁)×(K₂)×(K₃)× . . . (Kₙ), where each “K” represents a factor. For example, K₁ can represent the weight given to the age of the account, K₂ can represent the weight given to the frequencies of each payment within a predetermined time period, K₃ can represent the weight given to the increase or decrease of the currency amount of the current transaction compared to one or more prior transactions, K₁ can represent the weight given to customers who return to the same merchant and/or who are new customers to the merchant or to the system, and so on. Multiple other factors may be used to determine the number of tokens generated in each transaction. Further, a dividend (in the form of more tokens, cash, or other reward) can be provided to users who hold the proof of transaction tokens for a predetermined period of time, the amount being determined, for example, by the time the tokens are held and/or the number of tokens being held. The proof of transaction tokens maybe I the form of an existing cryptocurrency, a custom cryptocurrency, a points system being exchangeable for goods and/or services or discounts thereto. The proof of transaction tokens are stored with the user's wallet, either on the smartphone 26 or the hardware encryption device 22.

Aspects of the present specification can also be descripted as follows:
1. A system for authentication of cryptocurrency transactions, comprising: a hardware encryption device configured to generate and store a private encryption key, the hardware encryption device configured to connect to a smart computing device for signing a cryptocurrency transaction, wherein the smart computing device has a software application installed therefore for storing a public cryptocurrency key and communicating with a cryptocurrency network; a display component on which one or more biometric authentication elements are configured to capture a user's biometric credentials for authenticating the private encryption key for signing the cryptocurrency transaction, the one or more biometric authentication elements including at least one of a fingerprint scanner, a retinal scanner, a voice recognition scanner, and a facial recognition camera; and one or more transaction components configured to transmit a signed cryptocurrency transaction to the smart computing device when the user's biometric credentials confirm authenticity of the private encryption key, and initiate a broadcast of the signed cryptocurrency transaction from the smart computing device to the cryptocurrency network for verification of the signed cryptocurrency transaction by a miner computer.
2. The system of embodiment 1, wherein the hardware encryption device further comprises at least one connection port, wherein the hardware encryption device connects to a corresponding connection port on the smart computing device.
3. The system of embodiment 1 or 2, wherein the hardware encryption device connects to the smart computing device via a wireless connection between the hardware encryption device and the smart computing device.
4. The system of embodiment 3, wherein the wireless connection enables a contactless payment using one or more cryptocurrencies from the hardware encryption device.
5. The system of embodiment 3, wherein the wireless connection is a Bluetooth connection.
6. The system of embodiment 3, wherein the wireless connection is a near-field communication (NFC) connection.
7. The system of embodiment 3, wherein the wireless connection is a wireless local area networking (Wi-Fi) connection.
8. The system of any one of embodiments 1-7, wherein the hardware encryption device further comprises a battery for charging the smart computing device when the hardware encryption device is connected to the smart computing device.
9. The system of any one of embodiments 1-8, wherein the hardware encryption device further comprises a charging system for charging the smart computing device without a physical connection between the hardware encryption device and the smart computing device, wherein the charging system is at least one of a wireless charging system or an inductive charging system.
10. The system of any one of embodiments 1-9, wherein the hardware encryption device further comprises a memory component configured to allow the user to securely store files on the hardware encryption device.
11. The system of any one of embodiments 1-10, wherein the hardware encryption device is configured with near-field communications components to enable communication with point-of-sale systems for executing transactions with one or more cryptocurrencies.
12. The system of any one of embodiments 1-11, wherein the one or more transaction components are further configured to transfer an amount of a cryptocurrency from the hardware encryption device and the smart computing device only when the private encryption key is authenticated using the one or more biometric authentication elements.
13. The system of any one of embodiments 1-12, wherein the one or more transaction components are further configured to initiate writing of the signed cryptocurrency transaction on a blockchain after verification by the miner computer.
14. A method of authenticating a cryptocurrency transaction in a mobile computing environment, comprising: generating, from a hardware encryption device, a request for execution of a cryptocurrency transaction, and communicating the request to a smart computing device having at least one software application stored thereon for managing the execution of the cryptocurrency transaction; communicating a private encryption key to the smart computing device for confirmation of a public cryptocurrency key maintained on the smart computing device; initiating a biometric authentication of the cryptocurrency transaction, the biometric authentication including one or more of a fingerprint scanner, a retinal scanner, a voice recognition scanner, and a facial recognition camera configured to capture a user's biometric credentials; confirming the cryptocurrency transaction by matching the user's biometric credentials with a private encryption key to generate a signed cryptocurrency transaction; communicating the signed cryptocurrency transaction to the smart computing device; and initiating a broadcast of the signed cryptocurrency transaction from the smart computing device to a cryptocurrency network for verification of the signed cryptocurrency transaction by a miner computer.
15. The method of embodiment 14, further comprising defining a recipient address, a cryptocurrency type, and a cryptocurrency amount for the cryptocurrency transaction, in response to a request for transaction parameters from the smart computing device.
16. The method of embodiment 14 or 15, further comprising performing a currency conversion between different cryptocurrency types in response to the request to execute the cryptocurrency transaction.
17. The method of any one of embodiments 14-16, further comprising transferring an amount of a cryptocurrency between the hardware encryption device and the smart computing device in response to a user request to store the amount of the cryptocurrency on one or both of the hardware encryption device and smart computing device, wherein the amount of the cryptocurrency is transferred only when the private encryption key is authenticated using the biometric authentication.
18. The method of any one of embodiments 14-17, further comprising communicating a request to write a verified cryptocurrency transaction to a blockchain.
19. The method of any one of embodiments 14-18, further comprising charging the smart computing device when the hardware encryption device is connected to the smart computing device via connection ports on each of the hardware encryption device and the smart computing device.
20. The method of any one of embodiments 14-19, further comprising charging the smart computing device when the hardware encryption device is wirelessly connected to the smart computing device.
21. The method of any one of embodiments 14-20, further comprising securely storing one or more files on the hardware encryption device.
22. The method of any one of embodiments 14-21, wherein the hardware encryption device connects to the smart computing device via a wireless connection between the hardware encryption device and the smart computing device.
23. The method of embodiment 22, wherein the wireless connection enables a contactless payment using one or more cryptocurrencies from the hardware encryption device.
24. The method of embodiment 22, wherein the wireless connection is a Bluetooth connection.
25. The method of embodiment 22, wherein the wireless connection is a near-field communication (NFC) connection.
26. The method of embodiment 22, wherein the wireless connection is a wireless local area networking (Wi-Fi) connection.
27. A method of executing a secure cryptocurrency transaction in a mobile computing environment, comprising: receiving a request from a hardware encryption device for execution of a cryptocurrency transaction, the hardware encryption device connected to a smart computing device; confirming that a private encryption key generated by the hardware encryption device matches with a public cryptocurrency key in an application resident on the smart computing device; requesting one or more transaction parameters from the hardware encryption device, the one or more parameters including a recipient address, a cryptocurrency type, and a cryptocurrency amount for the outgoing cryptocurrency transaction; matching a requestor's biometric credentials with a private encryption key to confirm the cryptocurrency transaction and generate a signed cryptocurrency transaction, the requestor's biometric credentials captured by a display component on the hardware encryption device configured to allow the user to interact with one or more of a fingerprint scanner, a retinal scanner, a voice recognition scanner, and a facial recognition camera; receiving, at the smart computing device, the signed cryptocurrency transaction from the hardware encryption device; and broadcasting the signed cryptocurrency transaction to a cryptocurrency network for verification of the signed cryptocurrency transaction by a miner computer.
28. The method of embodiment 27, further comprising performing a currency conversion between different cryptocurrency types in response to the request to execute the cryptocurrency transaction.
29. The method of embodiment 27 or 28, further comprising transferring an amount of a cryptocurrency between the hardware encryption device and the smart computing device in response to a user request to store the amount of the cryptocurrency on one or both of the hardware encryption device and smart computing device, wherein the amount of the cryptocurrency is transferred only when the private encryption key is authenticated by the biometric credentials.
30. The method of any one of embodiments 27-29, further comprising charging the smart computing device when the hardware encryption device is connected to the smart computing device via connection ports on each of the hardware encryption device and the smart computing device.
31. The method of any one of embodiments 27-30, further comprising charging the smart computing device when the hardware encryption device is wirelessly connected to the smart computing device.
32. The method of any one of embodiments 27-31, wherein the hardware encryption device connects to the smart computing device via a wireless connection between the hardware encryption device and the smart computing device.
33. The method of embodiment 32, wherein the wireless connection enables a contactless payment using one or more cryptocurrencies from the hardware encryption device.
34. The method of embodiment 32, wherein the wireless connection is a Bluetooth connection.
35. The method of embodiment 32, wherein the wireless connection is a near-field communication (NFC) connection.
36. The method of embodiment 32, wherein the wireless connection is a wireless local area networking (Wi-Fi) connection.
37. The method of any one of embodiments 27-36, wherein the broadcasting the signed cryptocurrency transaction to a cryptocurrency network further comprises writing a verified cryptocurrency transaction to a blockchain.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular compound, composition, article, apparatus, methodology, protocol, and/or reagent, etc., described herein, unless expressly stated as such. In addition, those of ordinary skill in the art will recognize that certain changes, modifications, permutations, alterations, additions, subtractions and sub-combinations thereof can be made in accordance with the teachings herein without departing from the spirit of the present specification. It is therefore intended that the following appended claims and claims hereafter introduced are interpreted to include all such changes, modifications, permutations, alterations, additions, subtractions and sub-combinations as are within their true spirit and scope.

Certain embodiments of the present invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. For instance, as mass spectrometry instruments can vary slightly in determining the mass of a given analyte, the term “about” in the context of the mass of an ion or the mass/charge ratio of an ion refers to +/−0.50 atomic mass unit. At the very least, and not as an attempt to limit the application of the doctrine of equivalents to the scope of the claims, each numerical indication should at least be construed in light of the number of reported significant digits and by applying ordinary rounding techniques.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising”, variations thereof such as “comprise” and “comprises”, and equivalent open-ended transitional phrases thereof like “including,” “containing” and “having”, encompasses all the expressly recited elements, limitations, steps, integers, and/or features alone or in combination with unrecited subject matter; the named elements, limitations, steps, integers, and/or features are essential, but other unnamed elements, limitations, steps, integers, and/or features may be added and still form a construct within the scope of the claim. Specific embodiments disclosed herein may be further limited in the claims using the closed-ended transitional phrases “consisting of” or “consisting essentially of” (or variations thereof such as “consist of”, “consists of”, “consist essentially of”, and “consists essentially of”) in lieu of or as an amendment for “comprising.” When used in the claims, whether as filed or added per amendment, the closed-ended transitional phrase “consisting of” excludes any element, limitation, step, integer, or feature not expressly recited in the claims. The closed-ended transitional phrase “consisting essentially of” limits the scope of a claim to the expressly recited elements, limitations, steps, integers, and/or features and any other elements, limitations, steps, integers, and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps, integers, and/or features specifically recited in the claim whereas the meaning of the closed-ended transitional phrase “consisting essentially of” is being defined as only including those elements, limitations, steps, integers, and/or features specifically recited in the claim and those elements, limitations, steps, integers, and/or features that do not materially affect the basic and novel characteristic(s) of the claimed subject matter. Therefore, the open-ended transitional phrase “comprising” (and equivalent open-ended transitional phrases thereof) includes within its meaning, as a limiting case, claimed subject matter specified by the closed-ended transitional phrases “consisting of” or “consisting essentially of.” As such embodiments described herein or so claimed with the phrase “comprising” are expressly or inherently unambiguously described, enabled and supported herein for the phrases “consisting essentially of” and “consisting of.”

All patents, patent publications, and other references cited and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard is or should be construed as an admission that the inventors are not entitled to antedate such disclosure by virtue of prior invention or for any other reason. All statements as to the date or representation as to the contents of these documents is based on the information available to the applicant and does not constitute any admission as to the correctness of the dates or contents of these documents.

Lastly, the terminology used herein is for the purpose of describing particular embodiments only and is not intended to limit the scope of the present invention, which is defined solely by the claims. Accordingly, the present invention is not limited to that precisely as shown and described.

1. A system for authentication of cryptocurrency transactions, comprising:
a hardware encryption device configured to generate and store a private encryption key, the hardware encryption device configured to connect to a smart computing device for signing a cryptocurrency transaction, wherein the smart computing device has a software application installed therefore for storing a public cryptocurrency key and communicating with a cryptocurrency network;
a display component on which one or more biometric authentication elements are configured to capture a user's biometric credentials for authenticating the private encryption key for signing the cryptocurrency transaction, the one or more biometric authentication elements including at least one of a fingerprint scanner, a retinal scanner, a voice recognition scanner, and a facial recognition camera; and
one or more transaction components configured to transmit a signed cryptocurrency transaction to the smart computing device when the user's biometric credentials confirm authenticity of the private encryption key, and initiate a broadcast of the signed cryptocurrency transaction from the smart computing device to the cryptocurrency network for verification of the signed cryptocurrency transaction by a miner computer.

2. The system of claim 1, wherein the hardware encryption device further comprises at least one connection port, wherein the hardware encryption device connects to a corresponding connection port on the smart computing device.

3. The system of claim 1, wherein the hardware encryption device connects to the smart computing device via a wireless connection between the hardware encryption device and the smart computing device.

4. The system of claim 3, wherein the wireless connection enables a contactless payment using one or more cryptocurrencies from the hardware encryption device.

5. The system of claim 1, wherein the hardware encryption device further comprises a battery for charging the smart computing device when the hardware encryption device is connected to the smart computing device.

6. The system of claim 1, wherein the hardware encryption device further comprises a charging system for charging the smart computing device without a physical connection between the hardware encryption device and the smart computing device, wherein the charging system is at least one of a wireless charging system or an inductive charging system.

7. The system of claim 1, wherein the hardware encryption device further comprises a memory component configured to allow the user to securely store files on the hardware encryption device.

8. The system of claim 1, wherein the hardware encryption device is configured with near-field communications components to enable communication with point-of-sale systems for executing transactions with one or more cryptocurrencies.

9. The system of claim 1, wherein the one or more transaction components are further configured to transfer an amount of a cryptocurrency from the hardware encryption device and the smart computing device only when the private encryption key is authenticated using the one or more biometric authentication elements.

10. The system of claim 1, wherein the one or more transaction components are further configured to initiate writing of the signed cryptocurrency transaction on a blockchain after verification by the miner computer.

11. A method of authenticating a cryptocurrency transaction in a mobile computing environment, comprising:
generating, from a hardware encryption device, a request for execution of a cryptocurrency transaction, and communicating the request to a smart computing device having at least one software application stored thereon for managing the execution of the cryptocurrency transaction;
communicating a private encryption key to the smart computing device for confirmation of a public cryptocurrency key maintained on the smart computing device;
initiating a biometric authentication of the cryptocurrency transaction, the biometric authentication including one or more of a fingerprint scanner, a retinal scanner, a voice recognition scanner, and a facial recognition camera configured to capture a user's biometric credentials;
confirming the cryptocurrency transaction by matching the user's biometric credentials with a private encryption key to generate a signed cryptocurrency transaction;
communicating the signed cryptocurrency transaction to the smart computing device; and
initiating a broadcast of the signed cryptocurrency transaction from the smart computing device to a cryptocurrency network for verification of the signed cryptocurrency transaction by a miner computer.

12. The method of claim 11, further comprising defining a recipient address, a cryptocurrency type, and a cryptocurrency amount for the cryptocurrency transaction, in response to a request for transaction parameters from the smart computing device.

13. The method of claim 11, further comprising performing a currency conversion between different cryptocurrency types in response to the request to execute the cryptocurrency transaction.

14. The method of claim 11, further comprising transferring an amount of a cryptocurrency between the hardware encryption device and the smart computing device in response to a user request to store the amount of the cryptocurrency on one or both of the hardware encryption device and smart computing device, wherein the amount of the cryptocurrency is transferred only when the private encryption key is authenticated using the biometric authentication.

15. The method of claim 11, further comprising communicating a request to write a verified cryptocurrency transaction to a blockchain.

16. The method of claim 11, further comprising securely storing one or more files on the hardware encryption device.

17. A method of executing a secure cryptocurrency transaction in a mobile computing environment, comprising:
receiving a request from a hardware encryption device for execution of a cryptocurrency transaction, the hardware encryption device connected to a smart computing device;
confirming that a private encryption key generated by the hardware encryption device matches with a public cryptocurrency key in an application resident on the smart computing device;
requesting one or more transaction parameters from the hardware encryption device, the one or more parameters including a recipient address, a cryptocurrency type, and a cryptocurrency amount for the outgoing cryptocurrency transaction;
matching a requestor's biometric credentials with a private encryption key to confirm the cryptocurrency transaction and generate a signed cryptocurrency transaction, the requestor's biometric credentials captured by a display component on the hardware encryption device configured to allow the user to interact with one or more of a fingerprint scanner, a retinal scanner, a voice recognition scanner, and a facial recognition camera;
receiving, at the smart computing device, the signed cryptocurrency transaction from the hardware encryption device; and
broadcasting the signed cryptocurrency transaction to a cryptocurrency network for verification of the signed cryptocurrency transaction by a miner computer.

18. The method of claim 17, further comprising performing a currency conversion between different cryptocurrency types in response to the request to execute the cryptocurrency transaction.

19. The method of claim 17, further comprising transferring an amount of a cryptocurrency between the hardware encryption device and the smart computing device in response to a user request to store the amount of the cryptocurrency on one or both of the hardware encryption device and smart computing device, wherein the amount of the cryptocurrency is transferred only when the private encryption key is authenticated by the biometric credentials.

20. The method of claim 17, wherein the broadcasting the signed cryptocurrency transaction to a cryptocurrency network further comprises writing a verified cryptocurrency transaction to a blockchain.
